(19) United States
(12) Patent Application Publication
(10) Pub. No.: US 2015/0079416 A1
(43) Pub. Date: Mar. 19, 2015

(54) COMPOUND HIGH PRESSURE, HIGH TEMPERATURE TOOL

(71) Applicant: SANDVIK INTELLECTUAL PROPERTY AB, Sandviken (SE)

(72) Inventors: Stefan Ederyd, Saltsjo-Boo (SE); Erin Delmotte, The Woodlands, TX (US)

(21) Appl. No.: 14/484,287

(22) Filed: Sep. 12, 2014

Related U.S. Application Data
(60) Provisional application No. 61/877,409, filed on Sep. 13, 2013.

(51) Int. Cl. B30B 15/02; B22F 5/00; B22F 3/10; B22F 7/02; B22F 3/02

(52) U.S. Cl. CPC B30B 15/02; B22F 7/02; B22F 3/02; B22F 3/10; B22F 5/00; B22F 2005/002; B22F 2302/10; B22F 2302/406; B22F 2301/15
USPC 428/552; 428/565; 419/66; 419/6

(57) ABSTRACT

A tool for a high temperature, high pressure apparatus includes a working layer of a first hard metal composition of material and at least one supporting layer of a second hard metal composition of material attached to the working layer. The first hard metal composition has a mean linear intercept of less than about 0.4 μm of a binder phase. The working layer has a top and bottom surface. At least one supporting layer of a second hard metal composition of material is attached to the working layer. The at least one supporting layer includes an upper portion. An interface region is formed by the bottom surface of the working layer and the upper portion of the at least one supporting layer. The bottom surface and upper portion have a corresponding shape, wherein the bottom surface and upper portion are bonded to form the corresponding shape in the interface region.

### RELATED APPLICATION DATA

The present application is related to and claims the benefit of U.S. Provisional Patent Application No. 61/887,409 filed Sep. 13, 2013.

### TECHNICAL FIELD/INDUSTRIAL APPLICABILITY

A compound tool for a high pressure, high temperature system manufactured by fusing together two or several cemented carbide parts having different grades, for example, a compound anvil.

### BACKGROUND

The multi-anvil system or cubic system is the most developed and economical high pressure, high temperature system (HPHT), i.e., least cost per carat, that is used for making HPHT products. Also, service and the maintenance work costs are less than for the corresponding uniaxial V-shape and straight bore systems.

The HPHT cell/capsule is a cube that is compacted from six directions by the controlled movement of the pistons or anvils during the pressing procedure. The HPHT apparatus consists of the six pressing tools/anvils that work in three directions. Two of the anvils are electrical conductors to maintain electrical resistance heating of the HPHT capsule. The anvils are fitted into steel holders without radial pre-stresses. Forces on the anvils during the HPHT process are supplied from the support-plate at the bottom of the anvil and from the HPHT capsule and the gasket at the top-portion.

Cemented carbide pressing tools have been used in large scale/volume HPHT apparatus for many years. The tool set-up with cemented carbide pressing tools is used in uniaxial HPHT pressing system and in the anvils for the multi-axis/cubic system. The punches/anvils are typically made of solid cemented carbide.

The original HPHT tools concept with the punches separated in several parts have been replaced by a solid compound punch/anvil of cemented carbide. The new types of anvils are manufactured in two or several parts with two or several different CC-grades and are sintered together to form a “compound anvil.” Today it is this tool set-up used worldwide in the uniaxial HPHT pressing system and in the anvils for the multi-axis/cubic system.

Known compound anvils have a working layer having a higher hardness and supporting layers having a higher toughness than the working layer. These known anvils have not been an issue with the pressure that is generated in available capsules, however, there is a demand from the market for higher pressure in the cubic HPHT system. New demands of the HPHT process parameters have shown that the existing HPHT tools have got a limited or too low compressive strength to manage a high pressure up to 11 GPa. In such HPHT pressing apparatus systems, several materials interact during high pressure. Design analyses have not shown appropriate results with regards to the rheological properties of the used cemented carbide tools. With known stress-strain relationship of the carbide is it possible to get the true ultimate strength associated with brittle failure.

New demands of the HPHT process parameters have shown that the existing HPHT tools have limited, too low compressive strength to manage a pressure up to 11 GPa. To manage a bigger volume in a high pressure cell with a pressure up to 100-110 kBar (10-11 GPa), new anvils or other HPHT tools will be needed.

### SUMMARY

In one embodiment, a tool for a high temperature, high pressure apparatus includes a working layer of a first hard metal composition of material and at least one supporting layer of a second hard metal composition of material attached to the working layer. The first hard metal composition of the working layer has a mean linear intercept of less than about 0.4 μm of a binder phase.

In another embodiment, a tool for a high temperature, high pressure apparatus includes a working layer of a first hard metal composition of material. The working layer has a top and bottom surface. At least one supporting layer of a second hard metal composition of material is attached to the working layer. The at least one supporting layer includes an upper portion. An interface region is formed by the bottom surface of the working layer and the upper portion of the at least one supporting layer. The bottom surface and upper portion have a corresponding shape, wherein the bottom surface and upper portion are bonded to form the corresponding shape in the interface region.

In yet another embodiment, a method of forming a compound anvil for a high pressure, high temperature apparatus includes the steps of forming a first member of a first hard metal composition of material. The first hard metal composition of material has a mean linear intercept of less than about 0.4 μm of a binder phase. At least one other member of a second hard metal composition of material is formed. The first and at least one other member are assembled. The two or more members are joined to form a compound anvil.

In still another embodiment, a method of forming a compound anvil for a high pressure, high temperature apparatus includes the steps of forming a working layer of a first hard metal composition of material, the working layer having a top and bottom surface. At least one supporting layer of a second hard metal composition of material is formed, the at least one supporting layer having an upper portion. The working layer and at least one supporting layer are assembled such that the bottom surface of the working layer mates with the upper portion of the at least one supporting layer to form an interface region. The bottom surface and upper portion have a corresponding shape, wherein the bottom surface and upper portion are bonded to form the corresponding shape in the interface region. The working layer and at least one supporting layer are joined to form a compound anvil.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE DRAWINGS

FIG. 1 is a perspective view of a compound anvil according to an embodiment of the present disclosure.

FIG. 2 is a cross-section of the compound anvil of FIG. 1.

FIG. 3 is a micrograph performed with EBSD mapping.

FIG. 4 is a cross-section of another embodiment of a compound anvil.

FIG. 5 is a cross-section of yet another embodiment of a compound anvil.

FIG. 6 is a cross-section of still another embodiment of a compound anvil.

FIGS. 7(a)-7(c) are illustrations of the stress distributions of embodiments of the compound anvil.

FIGS. 8(a) and 8(b) are illustrations of the stress distributions of embodiments of the compound anvil.

FIG. 9 is a flow diagram of the methodology of forming a compound anvil according to the present disclosure.

FIG. 10 is a cross-sectional view of a HPHT belt press with compound anvils according to another embodiment.

FIG. 11 is a graph of axial stress and strain after one cycle of LCF.

### DETAILED DESCRIPTION

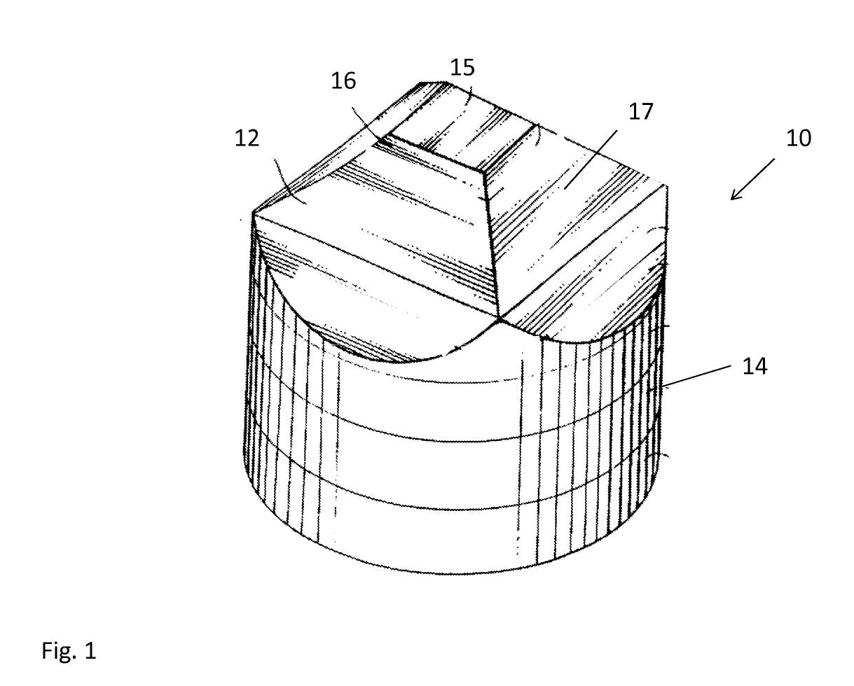

Referring to FIG. 1, an anvil 10 according to the present embodiments is manufactured by fusing together two or several cemented carbide parts with two or several different CC-grades to form a compound anvil. It should be appreciated that the present invention is not limited to an anvil, but encompasses other tools or components for use in a high pressure apparatus.

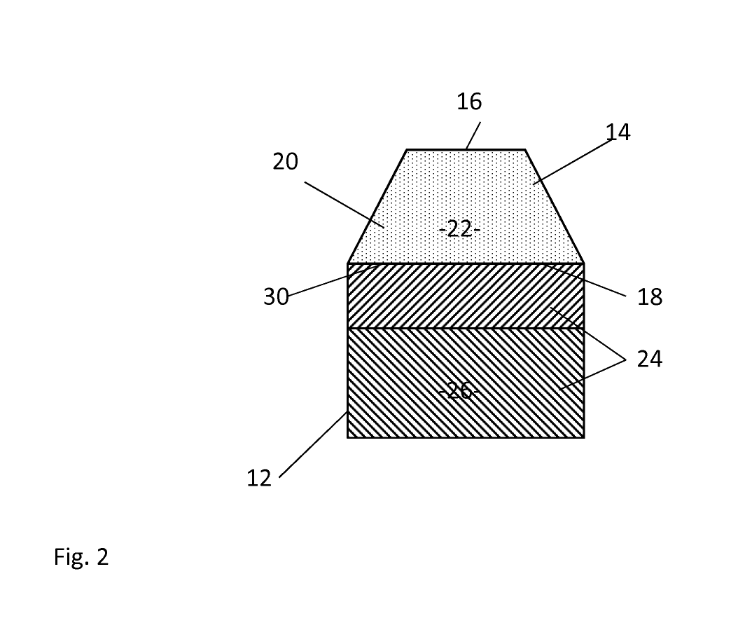

Anvil 10 includes a base 12 and head 14 located adjacent base 12. As shown in FIG. 2, head 14 includes a top surface 16 and a bottom surface 18. At least a portion or all of head 14 forms a working layer 20 of a hard metal composition of material 22. Base 12 is formed by at least one supporting layer 24 of a hard metal composition of material 26. Materials 22 and 26 can be cemented carbide of two or more different compositions and being different with respect to grade and/or grain size that are fused together, as will be described further herein.

Cemented carbides have a unique combination of high hardness and good toughness. Cemented carbide, as used herein, is defined as a hard, carbide phase, 70 to 97 wt-% of the composite and a metal alloy binder phase. Cemented carbides (CC) include straight grade carbide, which is the basic cemented carbide structure with grades formed by a composition of tungsten carbide and cobalt. P-grades or cubic grades consists of grades containing a significant proportion of γ-phase, (i.e. TiC, TaC, NbC etc.) together with WC and cobalt. Cemented carbide grades could contain grain growth inhibitors in small amounts and types of γ-phase formers. γ-phase formers or elements that tend to partition to the γ-matrix come from group III, IV, V and VI and include V, Cr, Ti, Ta, Nb, Zr. In addition, the cobalt binder phase can be alloyed with or completely replaced by nickel (Ni), chromium (Cr), iron (Fe), molybdenum (Mo) or alloys of these elements.

Cemented carbide grades can be classified according to the binder phase content and WC grain size. Different types of grades have been defined as fine, medium, medium course and coarse. As referred to herein, a fine grade can be defined as a material with a binder content of about 3% to about 20% and a grain size of less than about 1 μm, with nano, ultrafine and submicron fine grades having grain sizes of less than about 0.1 μm, about 0.1 to about 0.5 μm and about 0.5 to about 1 μm, respectively. Medium grades have binder content between about 6 to about 30% and a grain size of about 1 to about 3 μm. Medium coarse and coarse grades have binder contents between about 6 to about 15% and grain sizes above about 3 μm.

The hardness of cemented carbide depends upon the concentration and contiguity of the hard phase. For example, the higher the concentration of tungsten carbide the greater the hardness. Toughness, in turn, depends on the concentration of the binder. The higher the concentration of the binder the greater the toughness. Hence, by varying the composition, the resulting physical and chemical properties can be tailored to ensure maximum resistance to wear, deformation, fracture, corrosion, oxidation and other damaging effects. The available unique composition of cemented carbide also makes it an ideal tool material for HPHT apparatus operating at high pressures

As referred to herein a hard metal composition refers to a composite material normally having a hard phase composed of one or more carbides, nitrides or carbonitrides of tungsten, titanium, chromium, vanadium, tantalum, niobium, or an equivalent material, or a combination thereof, bonded by a binder or metallic phase typically cobalt, nickel, iron, or combinations thereof in varying proportions. Grade refers herein to cemented carbide as described above in one of several proportions and with a certain grain size.

Fine grade cemented carbide material having a WC grain size of less than about 1 μm offer a great challenge to measure grain size. Grain size has been conventionally measured by manual intercept measurements obtained from Electron backscatter diffraction (EBSD) images.

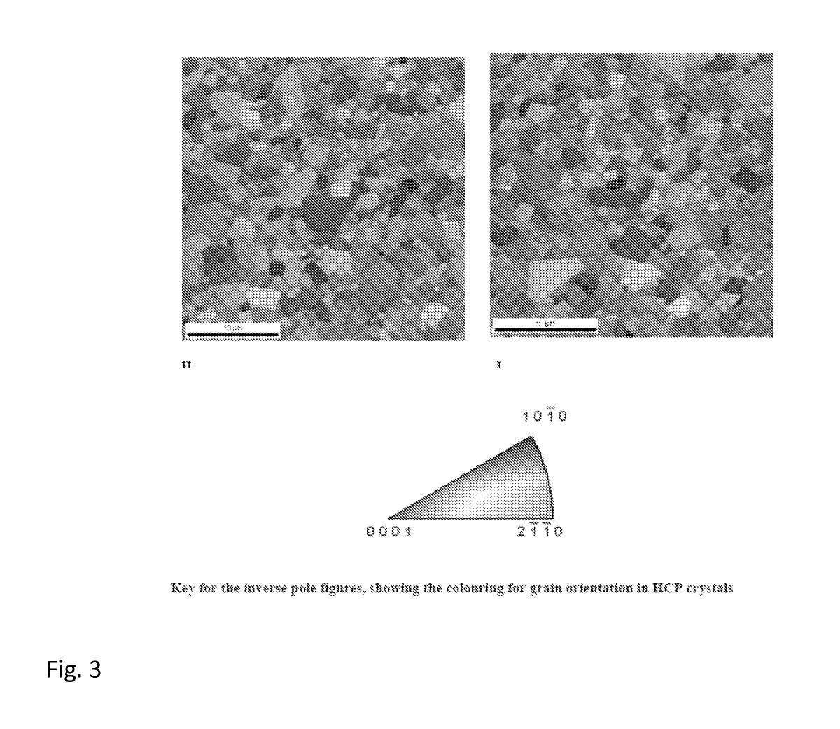

As used herein, grain size is defined as the equivalent circle diameter (ECD) of a hard grain. The ECD is the diameter of a circle with the same area as the grain. To determine average equivalent circle diameter a calculation can be made from the orientation maps generated with high quality EBSD from mounted and polished cross-sections of CC-specimens (FIG. 3). See Roebuck B, “Terminology, Testing, Properties, Imaging and Models for Fine Grained Hardmetals,” Int J Refract Hard Mater, 13 265-279 (1995), of which pages 271-272 and 274-276 are herein incorporated by reference.

As shown in Table 1 below, for various grades the calculated mean linear intercept (LB) of the cobalt-binder is less than about 0.40 μm. The linear intercept (LB) of the cobalt-binder is an indirect measurement of the volume fraction of cobalt and the WC grain size and can be calculated according to the formula:

LB_{Co}=d_{WC}(0.1+2.0 V_{Co})

where:

LB_{Co}=arithmetic mean linear intercept in the Co phase

d_{WC}=the Equivalent Circle Diameter of the WC grains

V_{Co}=Volume-% fraction of binder-phase.

### See Roebuck at 271.

TABLE 1

| | | | | | WC grain | Young's | | |
|---|---|---|---|---|---|---|---|---|
| | Co | Co | Coercivity | | size: μm | Modulus | Density | LB_{Co} :μm |
| Sample | wt % | vol % | kA/m | HV30 | ECD EBSD* | Gpa | g/cm³ | EBSD ECD |
| SHM-A | 3.3 | 5.7 | 31 | 1925 | 0.31 | 662 | 15.22 | 0.07 |
| SHM-B | 6 | 10.1 | 23.5 | 1775 | 0.41 | 630 | 14.89 | 0.12 |
| SHM-C | 10 | 16.3 | 20.4 | 1600 | 0.4 | 578 | 14.41 | 0.17 |
| SHM-D | 15 | 23.7 | 15.5 | 1380 | 0.42 | 525 | 13.91 | 0.24 |
| SHM-E | 6 | 10.1 | 18.5 | 1600 | 0.55 | 625 | 14.9 | 0.17 |
| SHM-F | 15 | 23.7 | 7.65 | 1095 | 1.38 | 533 | 13.99 | 0.79 |
| SHM-G | 20 | 30.5 | 7.6 | 1030 | 0.96 | 487 | 13.53 | 0.68 |
| SHM-H | 6 | 10.1 | 11.5 | 1440 | 1.06 | 630 | 14.93 | 0.32 |
| SHM-I | 10 | 16.3 | 7.5 | 1200 | 1.64 | 582 | 14.51 | 0.7 |
| SHM-L | 11 | 17.8 | 9.5 | 1250 | 1.05 | 572 | 14.41 | 0.48 |

*equivalent circle diameter-EBSD system software

Cemented carbide (CC) sample SHM-H is a straight grade of tungsten carbide (WC) and cobalt (Co) with a mean linear intercept calculation of grain size of less than 0.4 μm of the Co binder-phase. A Cobalt binder phase with a linear intercept less than 0.4 μm in a cemented carbide (CC) matrix has a major composition of a face center cubic (FCC) Co-phase. FCC phase metals are usually soft and ductile. Hexagonal closed packed (HCP) metals are less ductile, but stronger. FCC phase metals have more sliding directions than HCP phase metals. Due to the low stacking fault energy (SFE) of cobalt within the Co-binder a formation of a dislocations network can be more easily formed to provide a strain hardening of the binder-phase. This is of outermost importance to withstand the creep of the CC at high HPHT conditions.

Referring again to FIGS. 1 and 2, head 14/working layer 20 is in the form of a truncated pyramid and has the highest hardness and lowest toughness relative to supporting layer(s) 24. Working layer has a square end face 15 that faces into the high pressure cavity of the press. Four lateral faces 17 slope away from the edges of the end face at 45°.

Because working layer 20 is the layer that directly applies pressure to the material being pressed by the press, material 22 has a high hardness and high resistance to plastic deformation to ensure that a uniform ultra-high pressure can be applied to the material being pressed. Accordingly, to maintain an increase of the pressure in the HPHT cell to 11 GPa it is important to use a cemented carbide grade that can withstand the plastic deformation without crack formation in this most critical part of the anvil.

To achieve a high hardness, the layer is preferably fabricated from cemented tungsten carbide with a cobalt content of about 8% or less and an average tungsten carbide grain size of less than about 1 micron. For example, H6F, 8UF, 6UF grades can be used for the working layer, or other out CC grades with a CC composition between about 3 to about 10% Cobalt and a WC-grain size between about 0.3 to about 1 μm.

The high hardness makes the working layer brittle and more susceptible to cracking than softer layers. As set forth above, with finer grain size material the FCC phase dominates the Co-binder phase in CC grade with a binder phase intercept of less than about 0.4 μm. Accordingly, working layer 20 has a work hardening/dislocation formation within the CC during the first number of HPHT-runs that will increase the creep resistance and therefore enable the working layer to withstand higher pressure after a running-in period.

Supporting layer 24/base 12 has an upper portion 28. Upper portion 28 of base 12 and bottom surface 18 of head 14 are adjacent to form an interface region 30. As described above, base 12 can be a single supporting layer or a plurality of layers. Material 26 of the base and supporting layers is a soft cemented carbide grade that can manage the high stresses from the head 14 without breakage. Supporting layer can be replaceable to enable the hard working top to be reused.

The at least one supporting layer has a lower hardness than the working layer, with increased toughness for increased crack growth resistance. To achieve this, cemented tungsten carbide with a cobalt content of approximately 10% and an average carbide grain size of less than 1 μm is used. The layer material properties are selected so that the layer can withstand the high stress levels without subjecting the anvil to a substantial decrease in fatigue life.

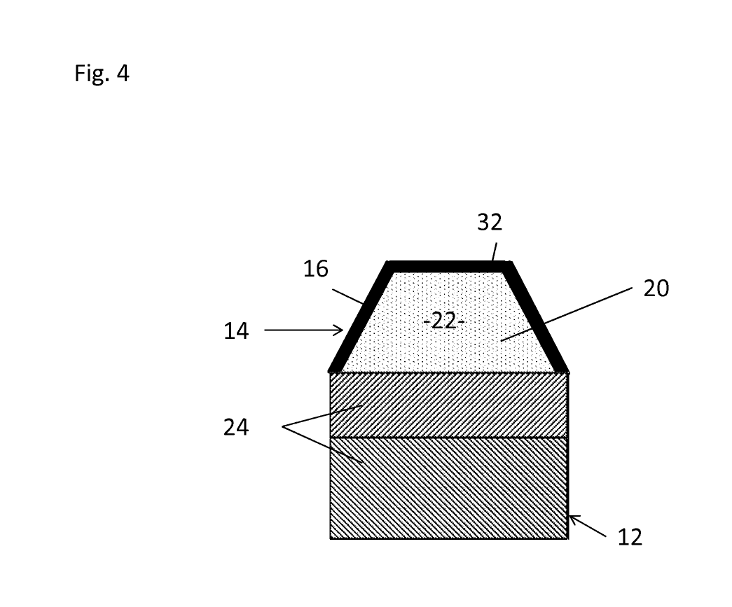

Referring to FIG. 4, top surface 16 of the anvil can include a volume of ultra-high pressure material (UHP) 32, e.g., polycrystalline diamond, disposed on top of the working layer 20. Volume 32 increases the hardness of head 14. The UHP material can be joined or fused to the top portion of the anvil as described further herein.

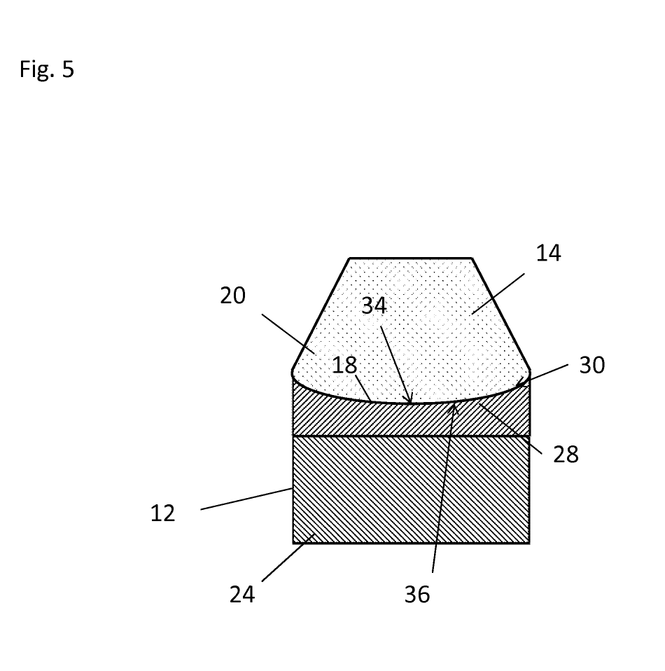

The shape of bottom surface 18 of working layer/head can have a flat (FIGS. 2 and 4) or a convex shape (FIG. 5) to provide a good distribution of the stresses from the taper top part of the anvil, as will be described further herein. Referring to FIG. 5, interface region 30 is formed by convex shape 34 of the working layer bottom surface 18 and a concave surface 36 of upper portion 28 of supporting layer 24. It should be appreciated that other shapes for the mating surfaces are contemplated.

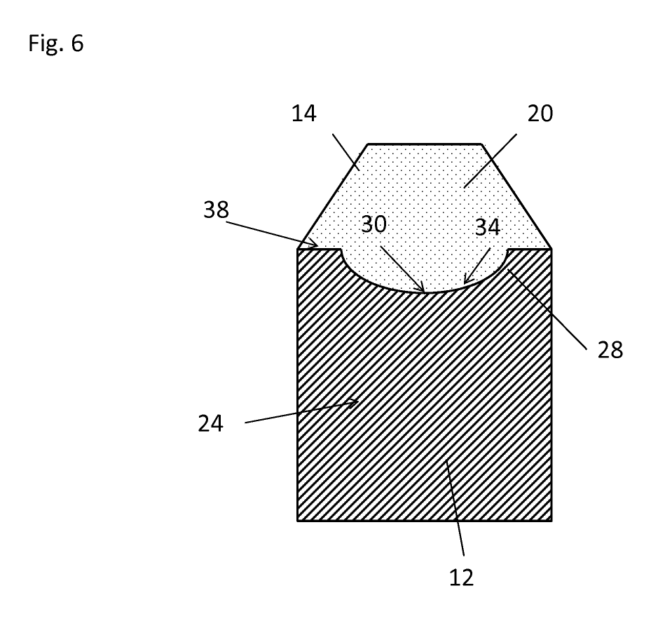

FIG. 6 illustrates another embodiment of a compound anvil that further alleviates stresses on the hard working layer. Bottom surface 18 of working layer 20 has a convex shape 34 surrounded by a shelf 38. Upper portion 28 of supporting layer 28 has a corresponding shape at interface region 30.

The carbide grades and the UHP grade used in the anvil have a high heat conductivity to manage an efficient cooling of the HPHT-tools during the HPHT-process. Also, the cemented carbide grades are good electrical conductors to manage the electrical heating possible in the HPHT capsule without heat losses in the anvils.

Thus, the capability of tailoring the compound anvil by use of cemented tungsten carbide layers of different grades allows for the incorporation of a very high hardness layer at the working face of the anvil. This gives the anvil the capability of applying uniform ultra-high pressure. Use of layers allows the incorporation of softer supporting layer(s) to prevent any cracks from traversing the anvil body. Tailoring the compound anvil using the different grades and thicknesses of layers allows for fabrication of a better performing anvil capable of withstanding its operating environment for consistently longer periods than existing anvils.

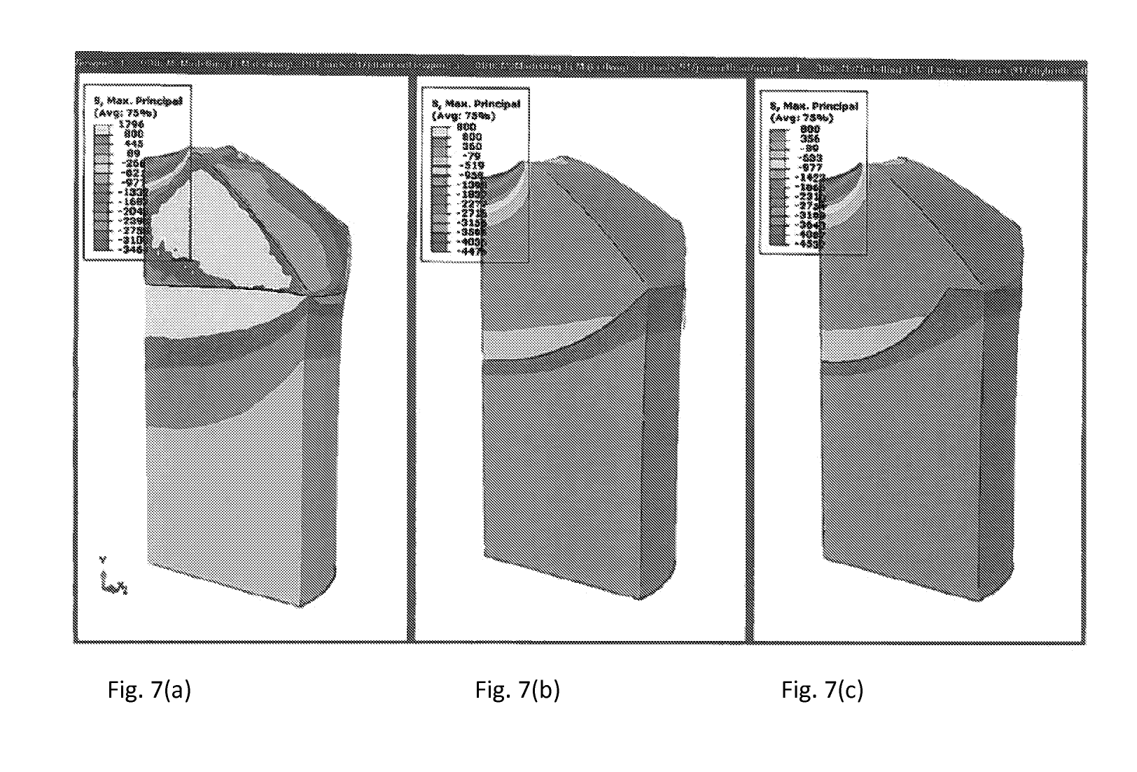

The corresponding shapes at the interface region between base 12 and head 14 have an impact on stress distribution in the compound anvil. Referring to FIGS. 7(a)-7(c), the principal stresses occurring during loading on the working face of the anvil are shown for a flat interface region (FIG. 7(a)); a convex/concave interface region (FIG. 7(b)); and an interface region with a shelf (FIG. 7(c)). As shown in FIG. 7(a), the flat joint shows higher principal stresses along the corners of the taper part of the anvil than the anvil of FIG. 7(b) having the concave/convex shape joints. The convex/concave joints give more support for plastic deformation especially in the corners. The joint shape with a shelf around the outer diameter, shown in FIG. 7(c) demonstrates a positive impact on the stress distribution in the corners.

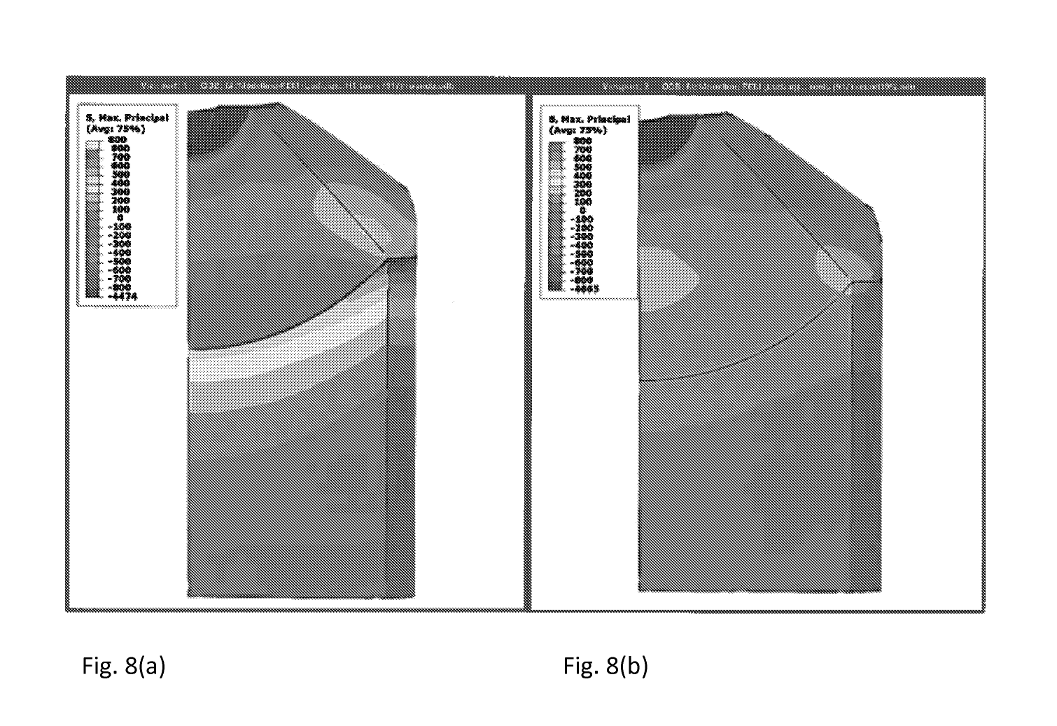

This issue for the anvils is the high stresses in the top portion that must manage the rheological properties/creep of the cemented carbide without resulting in fracture. The radius of the anvil also has an impact on stress distribution. Particularly, the distribution of the stresses in the joint of the anvil could be better distributed by making the anvil wider FIGS. 8(a) and 8(b), illustrate stress distribution with an anvil having a first radius (FIG. 8(a)) and an anvil having a radius that is about 10% larger in FIG. 8(b). As can be seen, the anvil with a 10% bigger radius had reduces stresses along the corners of the taper part.

Stresses can also be significantly by using a finer carbide grade with higher stiffness. Low cycle fatigue (LCF) studies of CC during HPHT conditions has shown a phase-transformation of FCC and BCC phases within the Co-binder to achieve deformation/strain hardening of the binder-phase. A finer grain size CC-material will transform the binder-phase making it easier to maintain a deformation hardening by dislocation formation.

A higher pressure in the HPHT-capsule of a cubic system is possible to maintain by changing the carbide grade to a stiffer grade with less creep at high pressure. The compound anvil concept makes it possible to utilize a stiffer grade with low risk of breakage in the contact area towards the support/back log plate. The fused compound carbide gives favorable compressive stresses in the joint/contact interface surface of the brittle/hard carbide type to resist prematurely failures during the HPHT-processes.

The shape of the fusing joint could be optimized according to size of the anvil and according to the pressing force applied: a compound anvil should have a radius of the convex/concave surface related to the outer diameter of the anvil. For the best performance of a compound anvil with an outer diameter D, the radius of the joint surface should be bigger than D/2 to a flat joint surface. The optimum radius of the top portion regarding favorable distributed stresses from forces applied at the anvil top surface is D/2 for the cubic HPHT-system with a taper angle of 45°. If the radius is smaller shear stresses in the joint volume could result in a cleavage of the anvil/tool. A radius bigger than D/2 to a flat surface gives a favorable stress pattern in the joint.

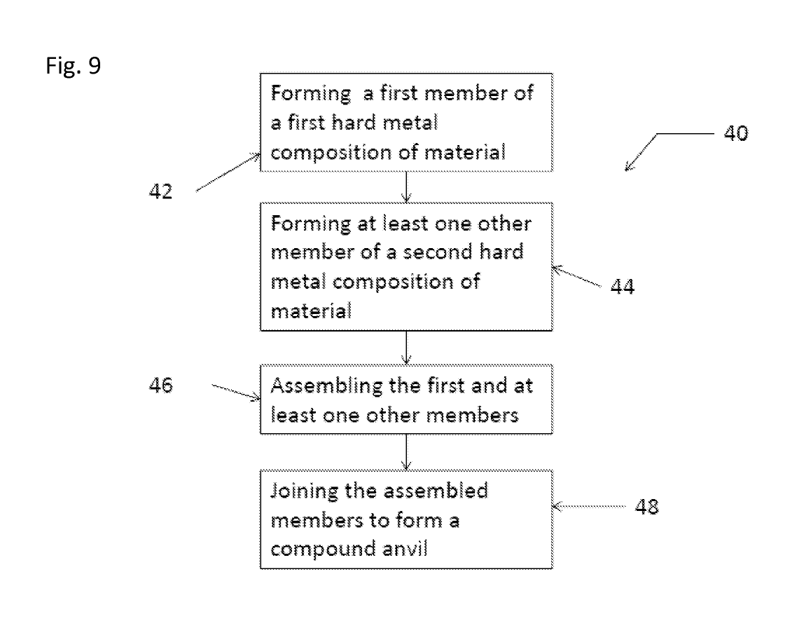

Referring to FIG. 9, a methodology 40 of forming a compound anvil is described. The compound anvils according to this embodiment can be manufactured by sintering together two or more cemented carbide parts with two or more different cemented carbide grades to form a compound anvil.

In step 42 a first member or working layer 20 of a first hard metal composition of material is formed. The first hard metal composition of material can be cemented carbide in the form of a tungsten carbide powder with a cobalt alloy binder powder having a high degree of hardness. The carbide and binder powder can be compacted as known, to form the first member or working layer. As described above, the first hard metal composition of material has a mean linear intercept of less than 0.4 μm of a binder phase.

At least one other member of a second hard metal composition of material is formed in step 44. This member can be at least one supporting layer, as described above that is a second cemented carbide material, different from the first cemented carbide of the working layers. As fully set forth previously, the at least one supporting layer has a high degree of toughness. Like, working layer 20, at least one supporting layer 24 can be formed by compacting carbide and binder powders.

In step 46, the first member or working layer 20 and at least one other supporting layer 24 are assembled by mating the bottom surface of the working layer and upper portion of the at least one supporting layer to form the corresponding shape in the interface region. The corresponding shapes can be formed on the members or layers by machining the corresponding surfaces. Moreover, during the assembly step a layer of ultra-hard material, for example, polycrystalline diamond/PCD can be disposed on the top of the working layer as described below.

The working layer and at least one supporting layer are joined to form the compound anvil in step 48. In the embodiment wherein a plurality of supporting layers is provided, the layers can be superimposed upon one another. In one example, two or several compacted layers of the cemented carbide powder (green bodies) are sintered together to a compound product with two different CC-grades. A known method of making powder-metallurgical articles includes making a compaction of two types of CC-powder of different CC-grades that are separated during the filling procedure of the powder pressing tool. After the sintering is the CC-body compound carbide of two CC-grades.

Alternatively, the members or layers can be sintered separately, assembled and then fused together by subjecting the assembled sintered members to a temperature and pressure sufficient to fuse the parts together to form the compound anvil.

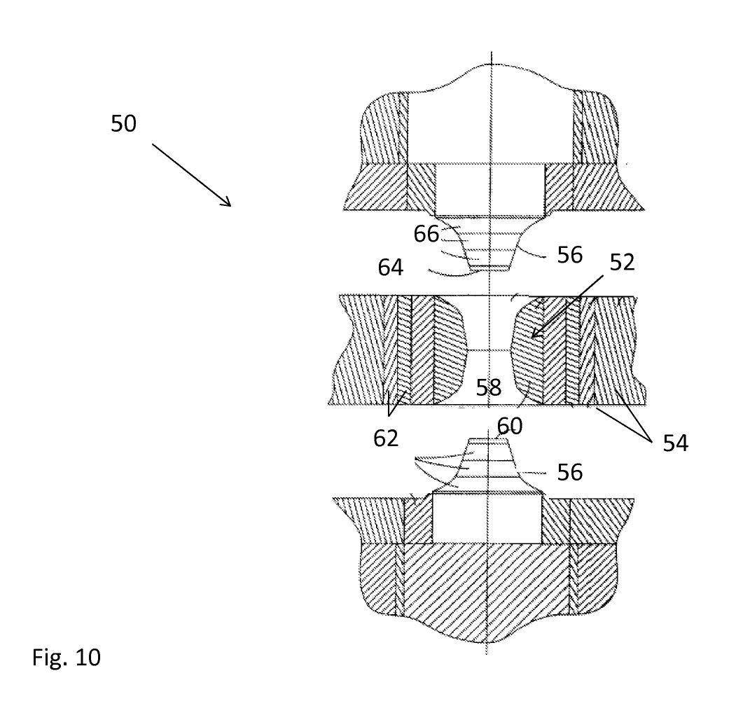

Another type of HPHT press commonly used is known as a belt press. As shown in FIG. 10, for such a uniaxial HPHT-pressing apparatus the HPHT-tool is divided in two punches and a die. A belt press 50 has an annular ring typically having a central annular body 52 of cemented tungsten carbide surrounded by an annular ring 54 of high strength steel shrunk onto the carbide ring. A pair of approximately conical cemented tungsten carbide anvils 56 move axially into tapered holes 58 in the belt for creating a high pressure within the belt between the anvils.

The techniques described herein may be used for fabricating the cemented tungsten carbide belt and anvils for a belt press. In such an embodiment, the annular working layer 60 of the belt which encounters high pressure is formed of hard material with less toughness. The supporting layers 62 of the belt are formed of somewhat softer, tougher cemented tungsten carbide. For purposes of this method, belts are equivalent to anvils and may be made with multiple layers of the same or differing grades of carbide. Each anvil has a working layer 64 at the tip that enters the hole in the center of the belt for applying high pressure. Supporting layers 66 behind the working layer are truncated cones and are of a softer, tougher material than the working layer.

The cross-section of the die in the axial direction shows a similar stress pattern as the anvils in the cubic HPHT-system. For the dies is it also possible to maintain a favorable stress pattern in the dies from the load applied by the HPHT cell. In this case is an inner-ring with a fine grained CC fused together with an outer ring of a tougher CC to maintain a stiffer HPHT-tool that could withstand the higher stresses with less bore expansion. The punches have a more favorable stress pattern than the corresponding anvils in the cubic system with regard to the pre-stresses at the outer diameter (OD) of the punches. To maintain a pressure up to 11 GPa the anvils must be designed and composed according to the present embodiments.

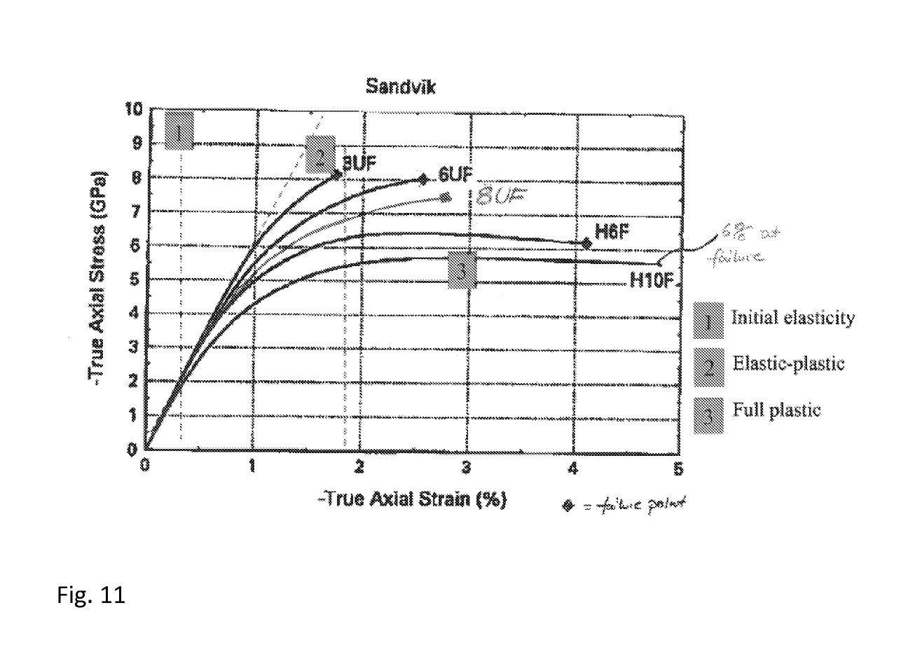

Referring to the graph of FIG. 11, the creep of CC described by the stress-strain rate during a first LCF-stress cycle is shown for various grades 3UF-H10F. As shown, the CC-grades, e.g. H10F, and softer grades could not reach a pressure up to 7 GPa.

To get an understanding of the Co-phase transformation with regards to the CC-hardening and the strength an X-ray diffraction analysis (XRD) was performed to quantify the different Co-phases.

The measurements have been performed directly on the polished sample surface. The samples were in an as-sintered condition. To quantify the content of the Co-phases a Rietveld refinement was used in the analysis. From the cobalt composition has only the cubic-Cobalt (phase 1013214) and the hexagonal-Cobalt (phase 311946) been chosen.

Results from the XRD analysis shown in Table 2 demonstrate that fine CC-grades have Fcc/cubic Co-phases in the binder-phase.

TABLE 2

| | Co-cubic | Co-hex | WC | Total |
|---|---|---|---|---|
| CC part | wt-% | wt-% | wt-% | content |
| SHM-C | 9 | 0.5 | 89.4 | 98.9 |
| Commodity | 0.4 | 10.6 | 87.8 | 98.8 |

Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

What is claimed is:

1. A tool for a high temperature, high pressure apparatus, the tool comprising:
a working layer of a first hard metal composition of material; and
at least one supporting layer of a second hard metal composition of material attached to the working layer, wherein the first hard metal composition of the working layer has a mean linear intercept of less than about 0.4 μm of a binder phase.

2. The tool of claim 1, wherein the first and second hard metal composition of materials each is cemented carbide.

3. The tool of claim 2, wherein the cemented carbide is a tungsten carbide bonded with a cobalt alloy binder.

4. The tool of claim 2, wherein the cemented carbide is from the group of tungsten, silicon, chromium, vanadium, tantalum, niobium, titanium, nickel, cobalt, iron or combinations thereof.

5. The tool of claim 1, wherein the first hard metal composition of material has a plastic deformation resistance to a pressure up to about 11 GPa.

6. The tool of claim 1, wherein the working layer has a top and bottom surface and the at least one supporting layer has an upper portion, and further comprising an interface region formed by the bottom surface of the working layer and the upper portion of the at least one supporting layer, the bottom surface and upper portion having a corresponding shape, wherein the bottom surface and upper portion are bonded to form the corresponding shape in the interface region.

7. The tool of claim 6, further comprising a volume of polycrystalline diamond disposed on the top surface of the working layer.

8. The tool of claim 6, wherein the bottom surface of the working layer has a convex shape and the upper portion of the at least one supporting layer has a corresponding concave shape.

9. The tool of claim 8, wherein the tool has an outer diameter D and the convex and concave shapes of the interface region have a radius that is larger than the outer diameter by D/2 of an interface region of a flat joint surface.

10. The tool of claim 1, wherein the tool is a compound anvil.

11. The tool of claim 1, further comprising a plurality of supporting layers.

12. The tool of claim 1, wherein the at least one supporting layer is replaceable.

13. The tool of claim 1, wherein the first hard metal composition of material is of a different grade than the second hard metal composition of material.

14. A tool for a high temperature, high pressure apparatus, the tool comprising:
a working layer of a first hard metal composition of material, the working layer having a top and bottom surface;
at least one supporting layer of a second hard metal composition of material attached to the working layer, the at least one supporting layer having an upper portion; and
an interface region formed by the bottom surface of the working layer and the upper portion of the at least one supporting layer, the bottom surface and upper portion having a corresponding shape, wherein the bottom surface and upper portion are bonded to form the corresponding shape in the interface region.

15. The tool of claim 14, wherein the first hard metal composition of material and the second hard metal composition of material each is cemented carbide.

16. The tool of claim 15, wherein the cemented carbide is a tungsten carbide bonded with a cobalt alloy binder.

17. The tool of claim 15, wherein the cemented carbide is from the group of tungsten, silicon, chromium, vanadium, tantalum, niobium, titanium, nickel, cobalt, iron or combinations thereof.

18. The tool of claim 14, wherein the first hard metal composition of material has a plastic deformation resistance to a pressure up to about 11 GPa.

19. The tool of claim 14, wherein the bottom surface of the working layer and the upper portion of the at least one supporting layer have a corresponding shape, wherein the bottom surface and upper portion are bonded to form the corresponding shape in the interface region.

20. The tool of claim 14, wherein the bottom surface of the working layer has a convex shape and the upper portion of the at least one supporting layer has a corresponding concave shape.

21. The tool of claim 20, wherein the tool has an outer diameter D and the convex and concave shapes of the interface region have a radius that is larger than the outer diameter by D/2 of an interface region of a flat joint surface.

22. The tool of claim 14, further comprising a volume of polycrystalline diamond disposed on the top surface of the working layer.

23. The tool of claim 14, wherein the tool is a compound anvil.

24. The tool of claim 14, further comprising a plurality of supporting layers.

25. The tool of claim 14, wherein the at least one supporting layer is replaceable.

26. The tool of claim 14, wherein the first hard metal composition of material has a mean linear intercept of less than about 0.4 μm of a binder phase.

27. The tool of claim 14, wherein the first hard metal composition of material is of a different grade than the second hard metal composition of material.

28. A method of forming a compound anvil for a high pressure, high temperature apparatus, comprising the steps of:
forming a first member of a first hard metal composition of material, the first hard metal composition of material having a mean linear intercept of less than 0.4 μm of a binder phase;
forming at least one other member of a second hard metal composition of material;
assembling the first and at least one other members; and
joining the two or more members to form a compound anvil.

29. The method of claim 28, wherein the first member is a working layer having a high degree of hardness.

30. The method of claim 28, wherein the first hard metal composition of material is cemented carbide.

31. The method of claim 30, wherein the cemented carbide is from the group of tungsten, silicon, chromium, vanadium, tantalum, niobium, titanium, nickel, cobalt, iron or combinations thereof.

32. The method of claim 28, wherein the at least one other member is at least one supporting layer having a high degree of toughness.

33. The method of claim 32, further comprising a plurality of supporting layers.

34. The method of claim 30, wherein the second hard metal composition of material is a second cemented carbide that has a different grade than the first hard metal composition of material.

35. The method of claim 34, wherein the second cemented carbide is a tungsten carbide powder and a cobalt alloy binder powder and the step of forming the at least one supporting layer includes compacting the carbide and binder powder.

36. The method of claim 35, wherein the working layer has a top and bottom surface and the at least one supporting layer has an upper portion, an interface region being formed by the bottom surface of the working layer and the upper portion of the at least one supporting layer, the bottom surface and upper portion having a corresponding shape, wherein the step of assembling the members includes mating the bottom surface and upper portion to form the corresponding shape in the interface region.

37. The method of claim 36, wherein the bottom surface of the working layer has a convex shape and the upper portion of the at least one supporting layer has a corresponding concave shape.

38. The method of claim 28, wherein the step of joining the members includes sintering the members to form a compound anvil.

39. The method of claim 28, further comprising the step of sintering each of the first members and the at least one other member prior to the step of assembling the members.

40. The method of claim 39, wherein the step of joining the members includes subjecting the assembled members to temperature sufficient to fuse the at least two sintered members together to form the compound anvil.

41. The method of claim 34, wherein the tool has an outer diameter D and the convex and concave shapes of the interface region have a radius that is larger than the outer diameter by D/2 of an interface region of a flat joint surface.

42. The method of claim 34, wherein the first hard metal composition of material has a plastic deformation resistance to a pressure up to about 11 GPa.

43. The method of claim 34, further comprising the step of positioning a volume of polycrystalline diamond on the top surface of the first member.
